(19) United States
(12) Patent Application Publication
(10) Pub. No.: US 2015/0317643 A1
(43) Pub. Date: Nov. 5, 2015

(54) SYSTEM AND METHOD FOR SIGNING ELECTRONIC DOCUMENTS

(71) Applicants: Shoaib Aftab MIAN, (US); Chris Lewis BAERWALDT, (US); David Tzer-Her HWANG, (US); Nhan Thanh NGUYEN, (US); COMMUNICATION INTELLIGENCE CORP., Redwood Shores, CA (US)

(72) Inventors: Shoaib Aftab MIAN, Dublin, CA (US); Chris Lewis BAERWALDT, Nepomuk (CZ); David Tzer-Her HWANG, Saratoga, CA (US); Nhan Thanh NGUYEN, Lafayette, CA (US)

(21) Appl. No.: 14/650,271

(22) PCT Filed: Dec. 6, 2013
(86) PCT No.: PCT/US2013/073723

§ 371 Date: Jun. 5, 2015

Related U.S. Application Data
(60) Provisional application No. 61/734,254, filed on Dec. 6, 2012.

(51) Int. Cl. G06Q 30/00; G06F 3/0488; H04W 8/20

(52) U.S. Cl. CPC G06Q 30/018; H04W 8/20; G06F 3/04883

(57) ABSTRACT

An apparatus for a signer to apply a signature to a signature field of an electronic document. A personal electronic device includes a browser application, a screen, and an input unit. A logic activates a web link on the personal electronic device with the browser application to connect the personal electronic device and a remote server via a communications network. A logic presents a signor-side image copy of the electronic document with the signature field on the screen of the personal electronic device. A logic accepts the signature of the signer into the signature field from the input unit of the personal electronic device. And a logic communicates the electronic document containing the signature of the signer to the remote server.

### CROSS-REFERENCE TO RELATED APPLICATIONS

This application is a 371 national stage of PCT/US2013/073723, filed Dec. 6, 2013, which claims the benefit of U.S. Provisional Application No. 61/734,254, filed Dec. 6, 2012, hereby incorporated by reference in their entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### COPYRIGHT NOTICE AND PERMISSION

This document contains some material which is subject to copyright protection. The copyright owner has no objection to the reproduction with proper attribution of authorship and ownership and without alteration by anyone of this material as it appears in the files or records of the Patent and Trademark Office, but otherwise reserves all rights whatsoever.

### BACKGROUND OF THE INVENTION

1. Technical Field

The present invention relates generally to the automated analysis of an image or recognition of a pattern, and more particularly to such for the purpose of recognizing an individual or verifying a person's identity.

2. Background Art

A signature serves an evidentiary function, traditionally to give evidence of the provenance of a document and of the intention of an individual with regard to that document. Historically signatures have been a hand applied depiction of someone's name, nickname, or even a simple mark that a person applies to documents as a proof of their identity and intent. In European-based cultures, hand applied signatures have usually been handwritten, or a mechanically applied equivalent that closely resembles a handwritten signature. In other cultures, however, other manners of hand applied signatures have been and continue to be used. Seals impressed in wax or clay, or onto paper or some other medium are examples. These may depict a name, position, or even an abstract symbol.

Of present interest is the act or ceremony of signature, and the parties involved. The writer of a signature is termed a “signatory” or “signer,” with the latter term used herein. In contrast, we herein use the term “agent” for a party seeking a signature or a party assisting a signer.

An example may help to clarify this. Bob wants to purchase an insurance policy and Alice is an employee of an insurance company. Alice provides an insurance contract, a document that will require Bob's signature. This document will also require a signature by Alice or another official of the insurance company, but this may already exist in the document or can be added later. At this point we are interested only in Bob's signature. Alice may conveniently and simply mail or transmit the document to Bob via facsimile, and he may sign it and mail or fax it back. In this scenario Bob is the signer and Alice is an agent. More typically, for a contract of such significance, Alice and Bob meet, they may discuss various terms in the contract, they may enter data into fields in the contract, and then Bob will apply his signature as Alice watches. Again, Bob is the signer and Alice is an agent.

Continuing with definitions that are used herein, were a document is signed is a termed “signature field.” A single document may have many signature fields. A document may also have “attention points,” such as terms in the example contract above. Bob may have something in the document he wants explained before he signs and Alice may have something in the document she wants to point out to Bob before he signs. Similarly, a document may have “data fields,” for Alice or Bob to enter data before Bob signs. For instance, Alice or Bob may enter a date in a data field. Signature fields, attention points, data fields, and the relationships between them are discussed further in the context of the present invention, below.

Changing tact, today we are starting to make wide use of electronic documents and of electronic signatures in such documents. Unfortunately, the use and acceptance of electronic signatures has proven problematical in some regards.

A first set of electronic signature problems are legal problems. Many of these have been resolved in many jurisdictions. These are not of particular interest here, aside from noting that better solutions to some of the technical problems with electronic signatures will assist in solving remaining legal problems and furthering acceptance in more jurisdictions.

Of present interest is the technology for collecting electronic signatures. A general definition of an electronic signature is “any electronic means that indicates . . . that a person adopts the contents of an electronic document.” References generally discuss three general classes of such electronic means: digitally captured signatures, biometric signatures, and cryptographic signatures.

Digitally captured signatures particularly include “dynamic signatures,” which are handwritten signatures that are digitized throughout the writing process. Dynamic signatures require a hardware device for signature capture, as well as software able to associate the resulting signature data with the electronic document. Typically, the signature data is combined into the electronic document and frequently encryption, hashing (a mathematical process to create a hash value), or other means are employed to allow detection later of any data manipulation (in the electronic signature and/or in the contents of the electronic document).

Some examples of common hardware devices used to collect dynamic signatures are pen pads, special pens, tablets, and other touch screen devices. In the case of specialized devices, such as special pads and pens, the manufacturer typically provides suitable software to operate the device and its presence is transparent to signers using these devices. In the case of general devices, such as tablet PCs and smart phones with touch screens, a manufacturer typically does not provide signature capture software. Instead, the user of such a device usually must procure and install application software (an app) in the device. If the user is an agent, working with many signers, this is arguably manageable. The agent procures the app needed for the type of electronic documents their business entails, installs and configures this app once, learns its use, and then has to be physically present with their device and the signer to collect signatures. In contrast, if a tablet PCs or smart phone owner is a signer and they want to use their own device, they are faced with procuring apps for each type of electronic document they may encounter, then installing (and after a one-time use perhaps uninstalling), configuring, troubleshooting (with potential issues due to conflicting past and present similar apps), learn to use the app, etc. Moreover, especially in this era of malware, many simply will not install an app unless it is procured from an utterly trustworthy party. In fact, many today simply will not install any apps beside those installed initially by the device manufacturer.

Today many digitizations of handwritten signatures are taken at a low resolution, and thus are very “two dimensional.” Dynamic signatures in the form of digitizations of seals are not widely used.

Turning next to biometric signatures, in the field of electronic signatures these are considered modern and emerging technology. Biometric characteristics typically considered are fingerprints, hand geometry (finger lengths and palm size), and iris and retinal patterns. Specialized devices are frequently needed to capture such data, although some tablet PCs and smart phones now have sensors that are theoretically capable of capturing some degree of fingerprint, iris, and retinal data. Many of the problems with digitally captured signatures apply as well to biometric signatures. Specialized devices are expensive and lack standardization, but are at least usable by agents who care do to so. The question for such agents, however, is why to bother. An agent has to be physically present with the signature device and the signer, when a simple handwritten signature on paper can be used instead, with scanning or facsimile if desired.

Digressing briefly, It is underappreciated, or at least alternately described that hand applied signatures have a long biometric history. For example, signature experts and even many others can readily tell if a signer signed using their right or left hand, or applied a seal using their right or left hand. Handwriting experts will also argue that pen-on-paper signatures contain many dimensions of data. There is the obvious two-dimension pigment pattern in the plane of the page, but also usually present are indications of pen pressure, orientation, stroke speed, etc. In deed, for important paper documents an ink thumb or palm print may be applied next to a hand applied signature.

Moving on to cryptographic signatures, these are hidden or secret data associated with an electronic signature or document (or both), typically with the signature and cryptographic data combined into the electronic document. Few forms of hand applied signature are a cryptographic signature, so cryptographic signatures serve as a good example here of how electronic signatures can provide advantages over hand applied signatures.

Many other capabilities of modern electronic devices have the potential to provide advantages over hand applied signatures. Many examples are already apparent, while others are emerging. Modern electronic devices can be personal, so that signers can be expected to trust in and be familiar with their own device. Such devices can also be portable or mobile, thus permitting signers to conduct business where they wish, and to an added extent when they wish. Electronic devices can communicate, with people on other devices and with other devices (e.g., servers). For instance, without limitation, automatic device-to-device communication can be of data for accurate time and location, or data for processor intensive operations or archival storage.

Summarizing, electronic signatures have both problems and promise. What is needed is an improved system for electronic signatures. Such an electronic signature system should have as many of the advantages of systems for hand applied signatures, yet such an electronic signature system should also be able to retain and employ as many of the advantages of modem electronic devices as possible.

### BRIEF SUMMARY OF THE INVENTION

Accordingly, it is an object of the present invention to provide a system for signing electronic documents.

Briefly, one preferred embodiment of the present invention is a process for a signer to apply a signature. For this the signer has a personal electronic device that includes a browser application, a screen, and an input unit. The personal electronic device of the signer is provided with a web link to an electronic document at a remote server, wherein the an electronic document includes a signature field. The web link is activated on the personal electronic device with the browser application, to form a connection between the personal electronic device and the remote server via a communications network. A signor-side image copy of the electronic document with the signature field is presented on the screen of the personal electronic device. The signature of the signer is accepted into the signature field from the input unit of the personal electronic device. And the electronic document containing the signature of the signer is communicated to the remote server.

Briefly, another preferred embodiment of the present invention is a computer program, embodied on a non-transitory, tangible computer readable storage medium. The program is for a signer to apply a signature, wherein the signer has a personal electronic device that includes a browser application, a screen, and an input unit. A code segment provides the personal electronic device of the signer with a web link to an electronic document at a remote server, wherein the an electronic document includes a signature field. A code segment activates the web link on the personal electronic device with the browser application to form a connection between the personal electronic device and the remote server via a communications network. A code segment that presents a signor-side image copy of the electronic document with the signature field on the screen of the personal electronic device. A code segment that accepts the signature of the signer into the signature field from the input unit of the personal electronic device. And a code segment communicates the electronic document containing the signature of the signer to the remote server.

And briefly, another preferred embodiment of the present invention is an apparatus for a signer to apply a signature to a signature field of an electronic document. A personal electronic device includes a browser application, a screen, and an input unit. A logic activates a web link on the personal electronic device with the browser application to connect the personal electronic device and a remote server via a communications network. A logic presents a signor-side image copy of the electronic document with the signature field on the screen of the personal electronic device. A logic accepts the signature of the signer into the signature field from the input unit of the personal electronic device. And a logic communicates the electronic document containing the signature of the signer to the remote server.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a stylized overview of the inventive signature system being employed;

FIG. 2 shows an agent's view of an electronic document on a terminal;

FIG. 3 shows a signer's view of the screen of an electronic device, which here includes icons to activate a browser and other applications;

FIG. 4 stylistically shows how the agent requests the signer enter into a ceremony to sign the electronic document;

FIG. 5 shows the signer having received a web link in an image copy of the document with a QR code bearing the web link superimposed on the first page of the document;

FIGS. 6a-b respectively show what the signer sees on their electronic device and what the agent sees on their terminal, as a formal signature scenario commences;

FIGS. 7a-c show how the same views of the document are presented to the signer and the agent as the signer browses to a different location in the document;

FIGS. 8a-b show the signer and the agent having co-browsed to the end of the document;

FIG. 9 shows the signer having returned to page one of the document and there activated a first signature field;

FIGS. 10a-b respectively show what the signer sees on his electronic device and what the agent sees on his terminal, as the signer signs the document;

FIG. 11 shows a written signature box (FIG. 10a) having been replaced by a text signature box, into which the signer is entering their signature as text;

FIG. 12 shows how the written signature box reappears and what will be entered as the signature, once the signer operates an enter button;

FIGS. 13a-b respectively show what the signer sees on his electronic device and what the agent sees on his terminal, after the signer has operated the OK button;

FIG. 14 shows the written signature box again, with the signer alternately entering their signature in a manner that may not be aesthetically pleasing;

FIG. 15 is a stylized overview of the inventive signature system being employed, wherein some more detail than FIG. 1 is in some respects, some redundant detail is omitted, and some optional features are introduced;

And FIG. 16 is a block diagram showing details of a signature in a document, once applied by the signature system.

In the various figures of the drawings, like references are used to denote like or similar elements or steps.

### DETAILED DESCRIPTION OF THE INVENTION

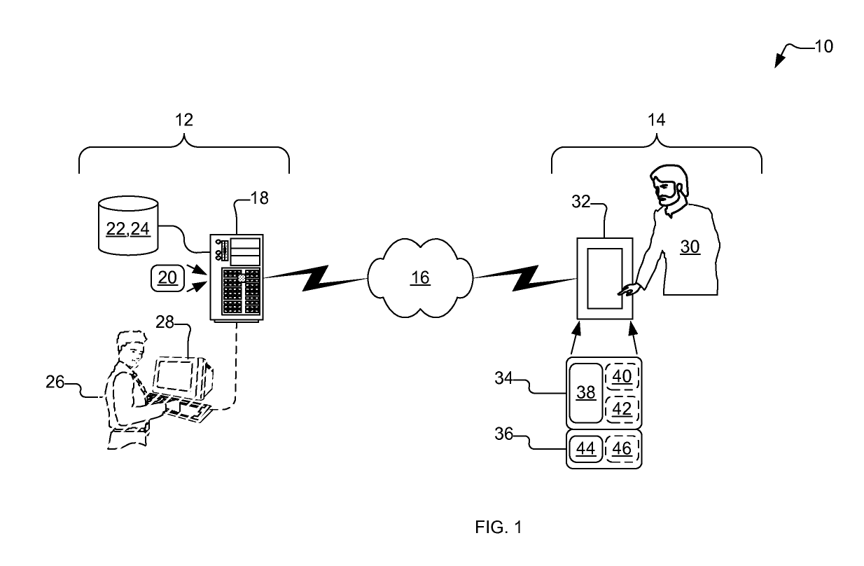

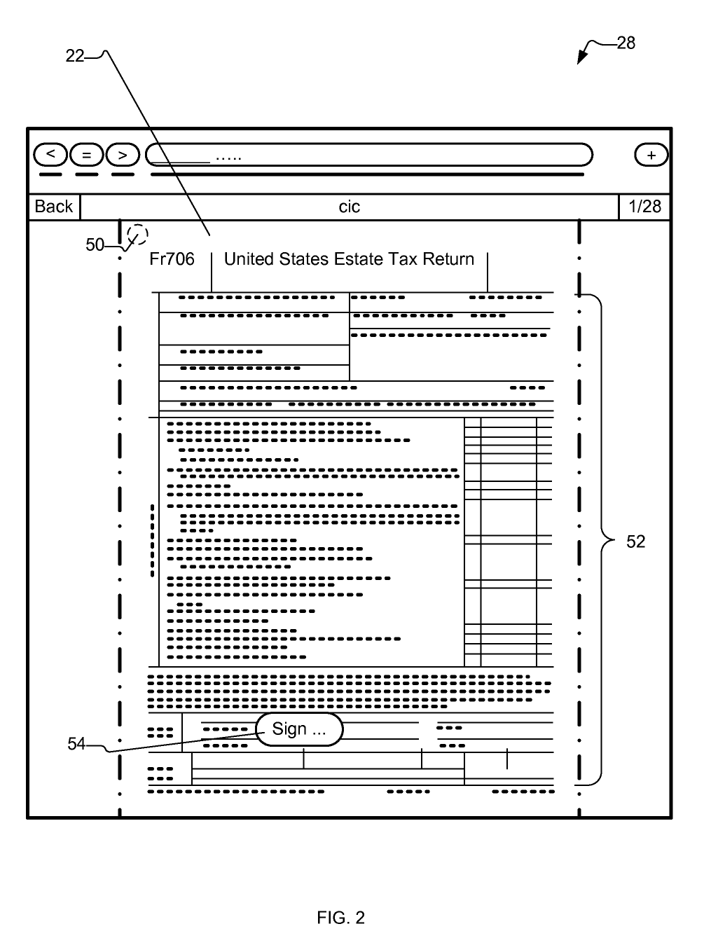

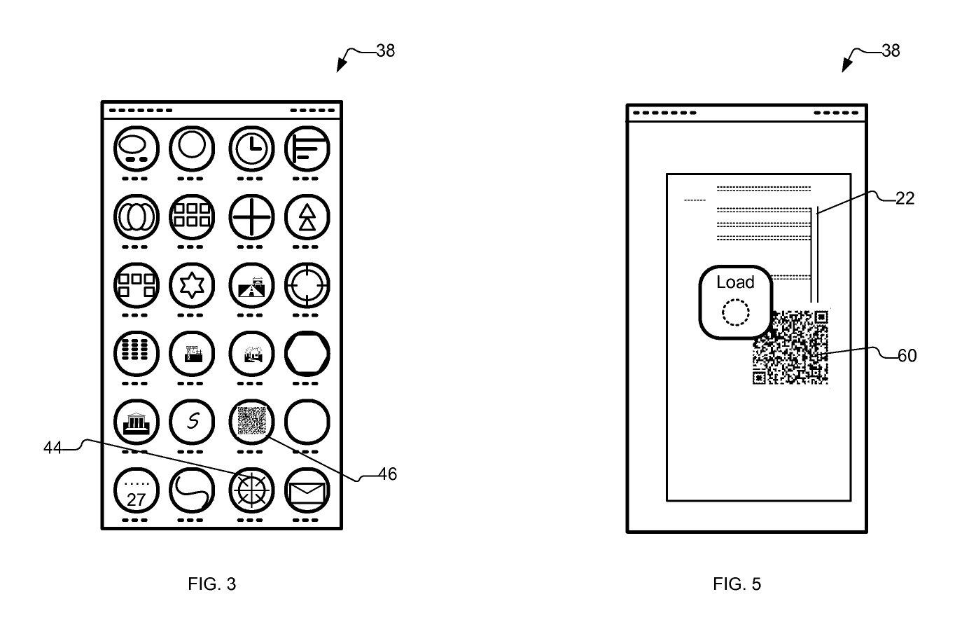

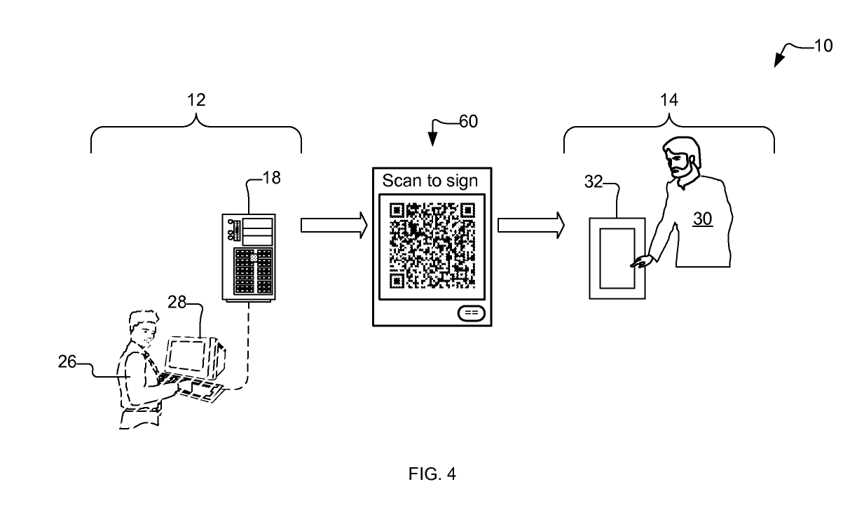

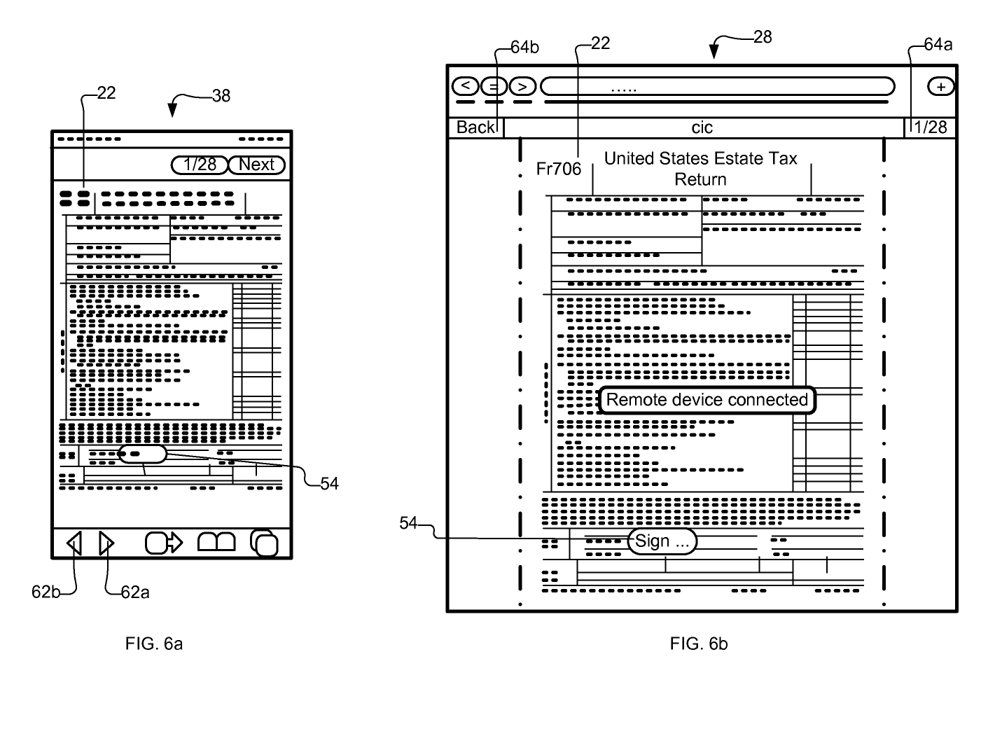

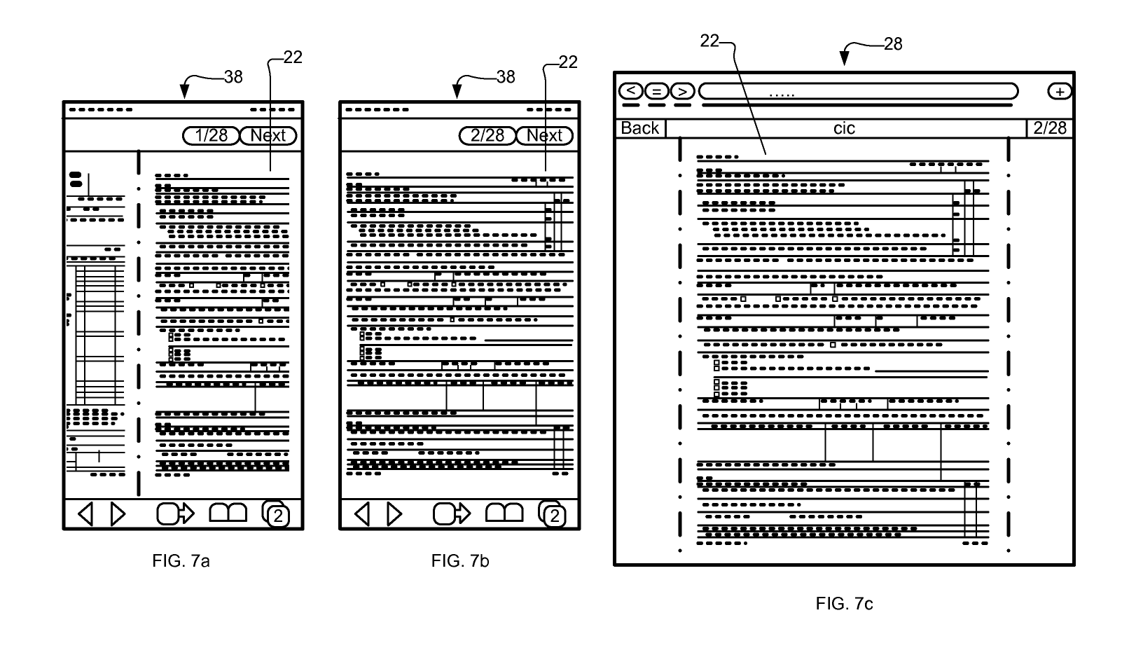

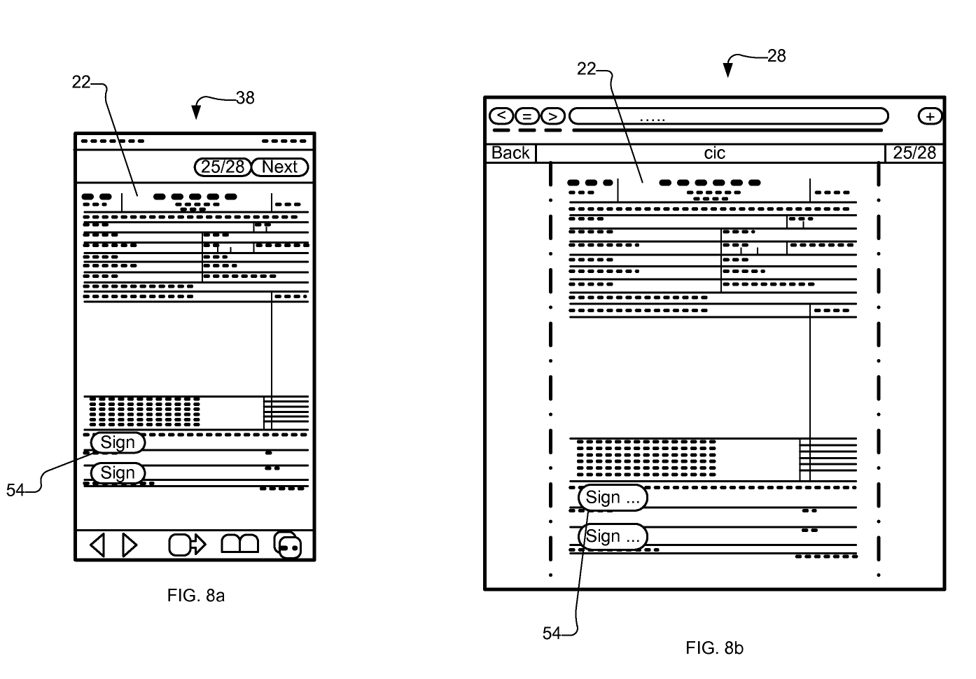

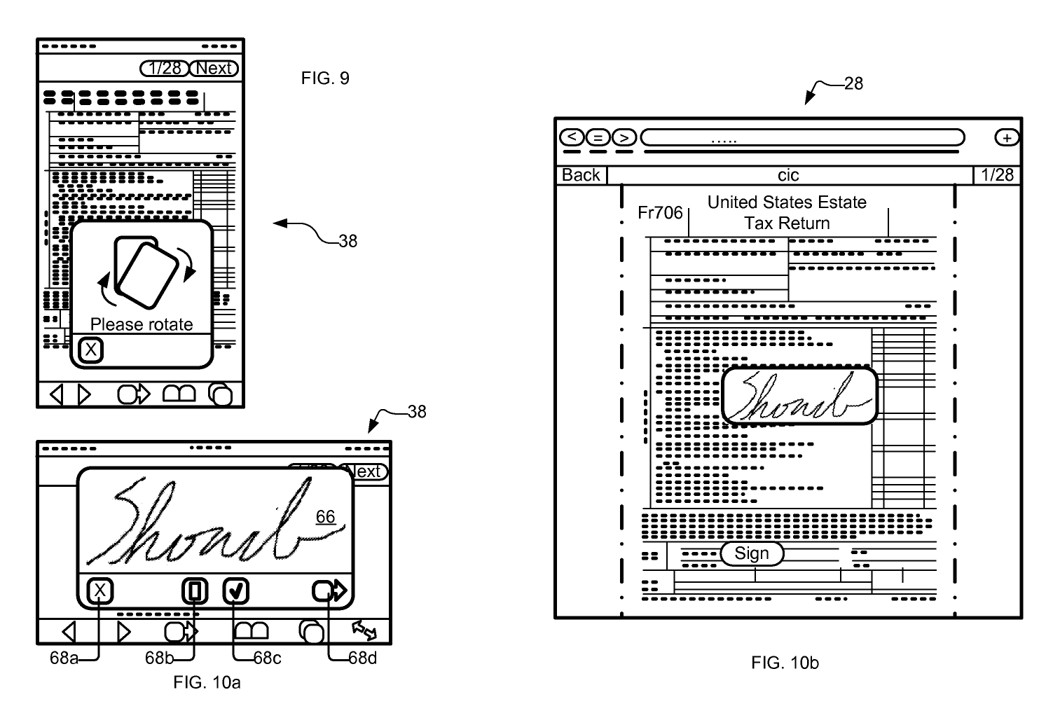

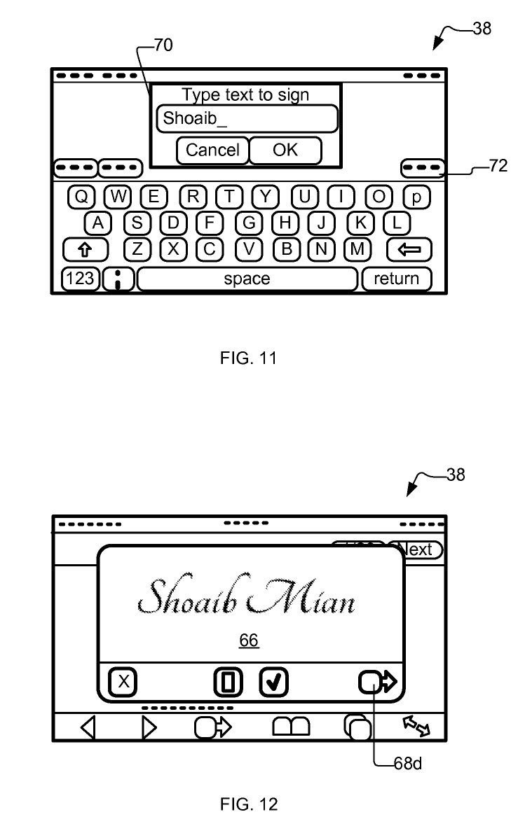

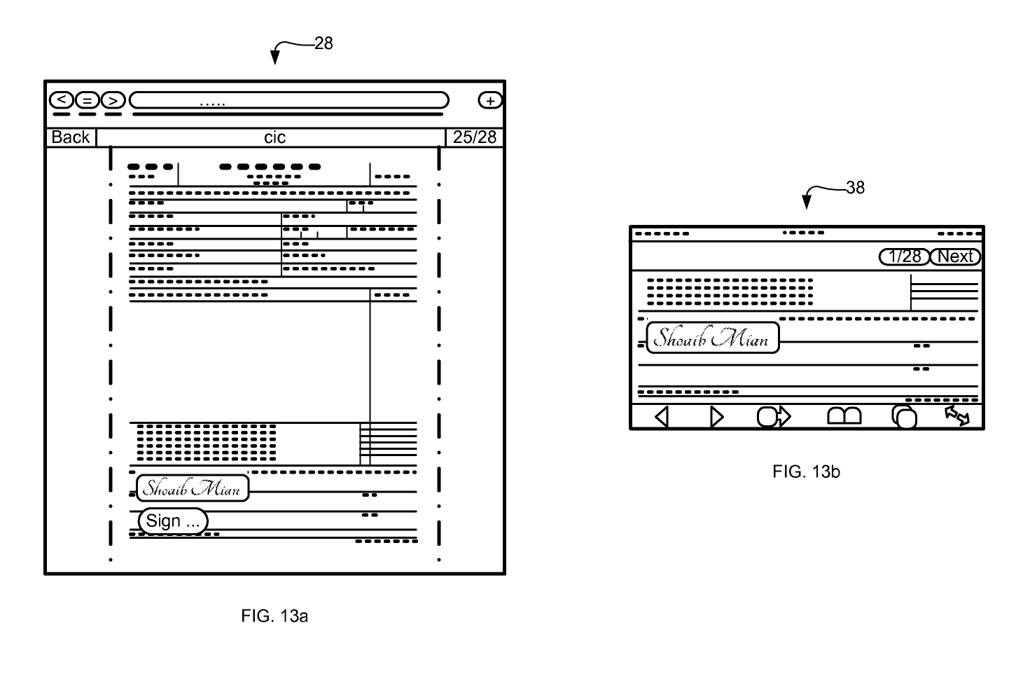

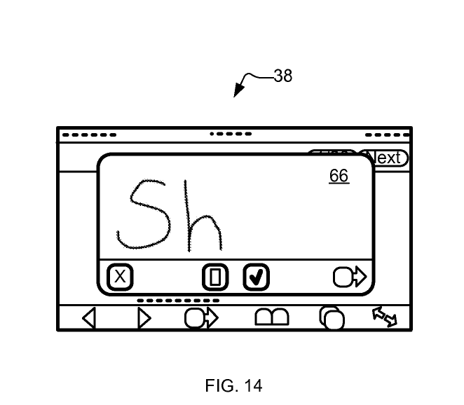

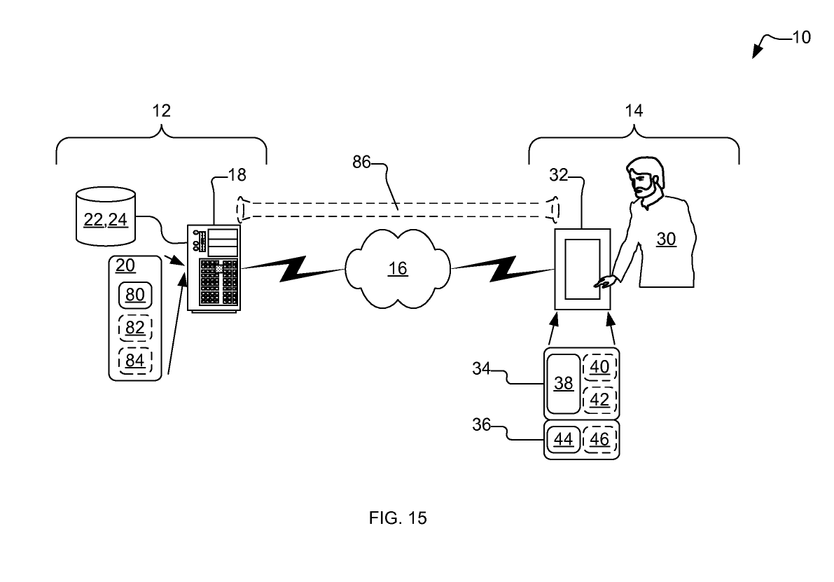

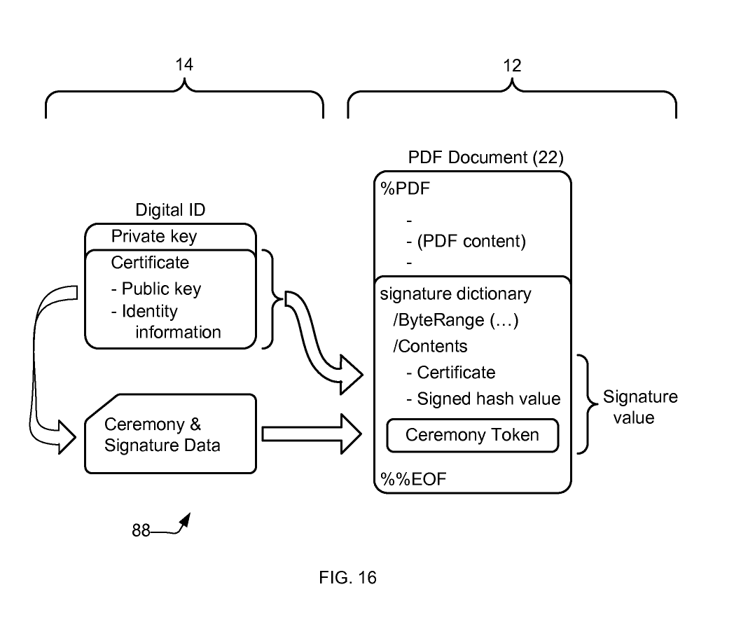

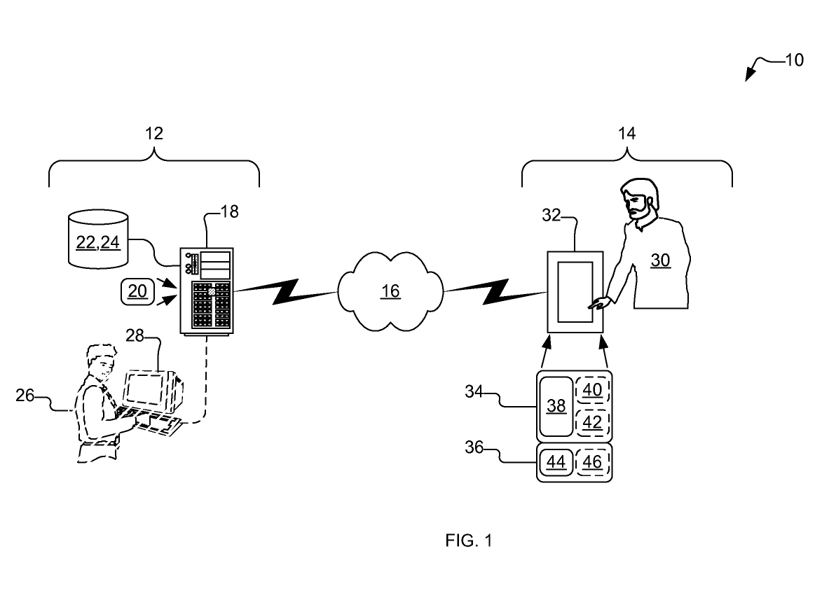

A preferred embodiment of the present invention is a system for signing electronic documents, as illustrated in the various drawings herein, and particularly in the view of FIG. 1, wherein the embodiment of the invention are depicted by the general reference character 10.

FIG. 1 is a stylized overview of the inventive signature system 10 being employed. Optional elements here are depicted in ghost outline. The signature system 10 has an agent-side 12, a signer-side 14, and a communications network 16 connecting these. The term “agent” is used in a general sense in this discussion, and not necessarily in accord with the legal definition of an agent or any definition particular to any industry. An agent here can be the originator of the document, or simply a requesting party who assists a signer in executing the document.

The agent-side 12 includes a server 18 that runs a server application 20 and that is able to access at least one electronic document 22. Typically the server 18 and a server application 20 have access to many such documents 22 stored in a database 24. Optionally, an agent 26 with a terminal 28 may be present and may employ the server 18, server application 20, electronic documents 22, and database 24 to interact with the signer-side 14 in real time.

The signer-side 14 includes a signer 30 who has a personal electronic device 32. The personal electronic device 32 may particularly be a mobile type device. The electronic device 32 characteristically has hardware components 34 and software components 36.

The hardware components 34 of the electronic device 32 include those typically necessary in generic personal/mobile electronic devices, and here the electronic device 32 particularly includes a screen 38. The screen 38 is able to display information to the signer 30, and it may also be capable of accepting the input of information from the signer 30 (e.g., the screen 38 may be a touch screen). Optionally, the hardware components 34 may include other output units 40 (e.g., an audio or vibrate output unit). The hardware components 34 may also include other input units 42 (e.g., a microphone or key-pad unit). If the screen 38 is not capable of accepting information from the signer 30, at least one other input unit 42 will be present. The other input units 42 may be optional when the hardware components 34 include a screen 38.

The software components 36 include those typically necessary in generic personal/mobile electronic devices (e.g., an operating system), and here the electronic device 32 particularly includes a browser application 44. Optionally, the software components 36 may also include other applications 46 (e.g., an application capable of reading QR codes).

The communications network 16 is straightforward and may be entirely conventional.

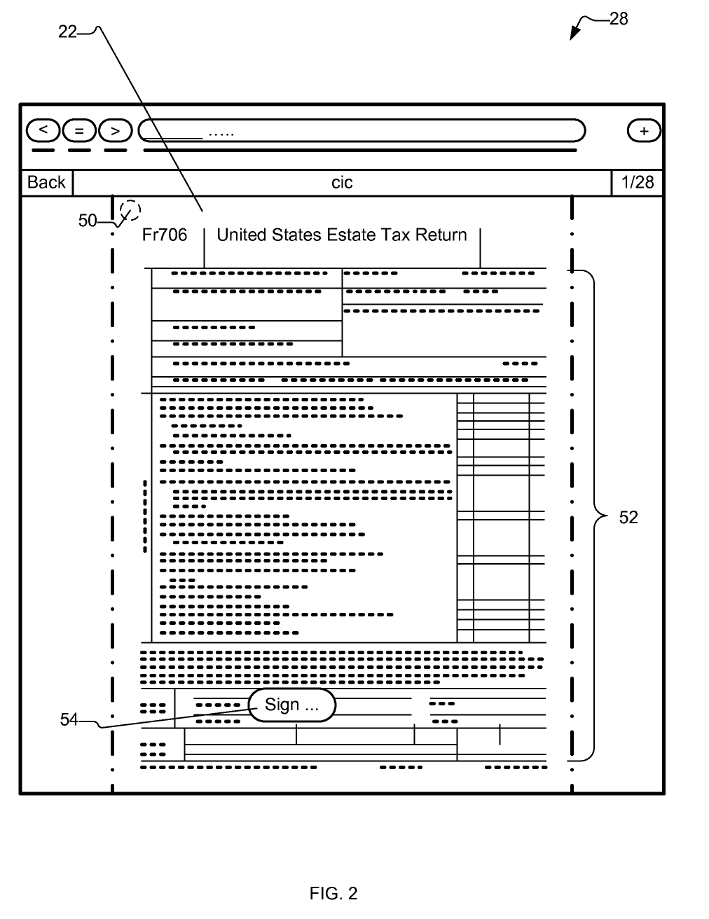

FIGS. 2-14 are views as seen by an agent 26 and a signer 30 as they use the signature system 10 in a now discussed example scenario.

In FIG. 2 the agent 26 is viewing a twenty-eight page electronic document 22 on their terminal 28. For instance the document 22 may be in the widely used Portable Document Format (PDF). The terminal 28 may be any device suitable for use in the manner now described, and thus may be, for example, a conventional personal computer.

Continuing with FIG. 2, shown here in the first page of the document 22 are an attention point 50, many data fields 52, and a signature field 54. Attention points 50 and data fields 52 are optional. In contrast, a document 22 here will obviously have at least one signature field 54, since the very point of this signature system 10 is to sign the document 22.

An attention point 50 is a location in the document 22 where the attention of a user (agent 26 or signer 30) is directed. The attention point 50 in FIG. 2 is at the very beginning of the document 22 (first page, top, left), thus the view (i.e., the focus) of the user is brought here first. The attention point 50 here is shown in ghost outline to emphasize that it may or may not be visible, as a matter of design choice.

In many respects, attention points 50 can be similar to book markers in conventional electronic document. However, unlike such markers which a user may not even be aware are present or may simply ignore, an attention point 50 is always navigated to and an affirmative effort must be made to navigate away. Attention points 50 can be navigated through in the manner of following a link or jumping to a particular location in a document. When at a given attention point 50, a next or back operation will (in the manner of following a link or jumping to a different location) navigate within the document 22 to a next or previous attention point 50 or signature field 54.

Data fields 52 are straightforward and may be entirely conventional. Simply put, they are fields were data may, should, or must be entered in an electronic document 22. A data field 52 may or may not be paired with an attention point 50, say, to bring the attention to a data field 52 into which data must be entered.

The underlying mechanisms of signature fields 54 are discussed in detail presently. Conceptually, a signature field 54 operates similar to an attention point 50 with respect to navigation within a document 22. Signature fields 54 can be link-wise or jump-wise navigated through. When at a given signature field 54 a next or back operation will navigate to a next or previous signature field 54 or attention point 50.

As noted, attention points 50 and data fields 52 are optional features of electronic documents 22 used with the inventive signature system 10. If these features are present, a basic embodiment of the signature system 10 need not even detect their presence, yet such an embodiment can still be used for signing the document 22.

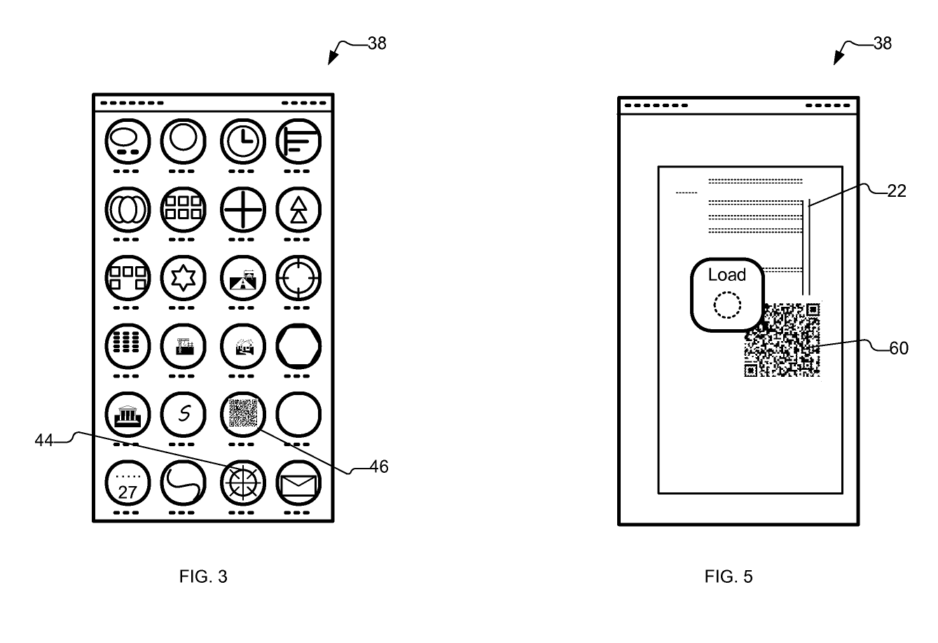

In FIG. 3 the hypothetical signer 30 is viewing the screen 38 of their electronic device 32, which here is showing icons to activate the browser application 44 as well as one particular other application 46 that here is capable of reading Quick Response (QR) codes.

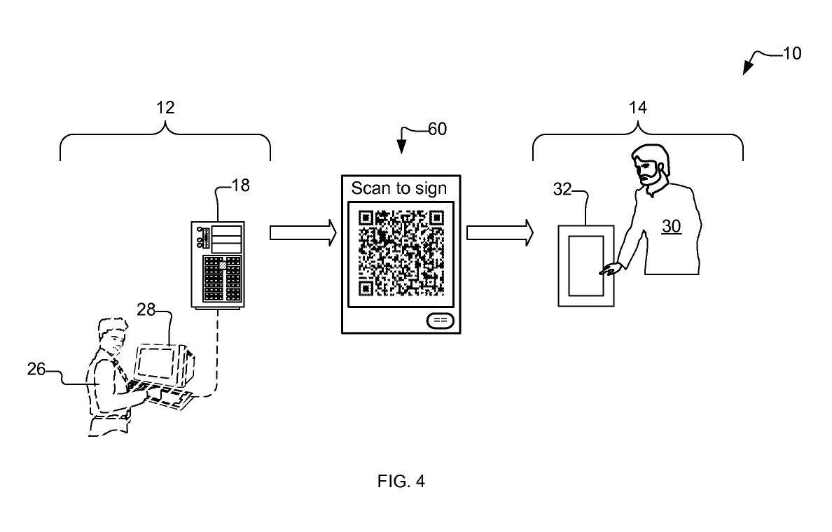

FIG. 4 stylistically shows how the agent 26 requests the signer 30 enter into a ceremony to sign the electronic document 22. The agent 26 provides the signer 30 with a web link 60 to the server application 20. In the example here, the web link 60 is embedded in a QR code, and the manner of delivering the web link 60 can be any that permits the QR code being read by the electronic device 32 of the signer 30. For example, the QR code can be sent electronically as an image or printed on paper, sent via postal mail, and captured into an electronic image. Any manner of providing the web link 60 is usable, and some other mechanisms are discussed presently.

In FIG. 5 the hypothetical signer 30 has received the web link 60, as an image copy of the electronic document 22 with the QR code bearing the web link 60 superimposed on the first page. And the signer 30 is here using the QR code reader other application 46 in their electronic device 32 to read the QR code and operate the web link 60. Depending on the QR code reader application used, or its configuration, employment in their browser application 44 may occur automatically or the signer 30 may have to direct the QR application to pass control to the browser application 44.

Some key points of novelty should be noted here. The signer 30 only needs the electronic device 32, which can easily be their own trusted and familiar electronic device 32. The electronic device 32 needs to have some manner of data input mechanism, but most electronic devices 32 today include one or more suitable such mechanisms. In the example here the data input mechanism is the QR core reader application. An alternate mechanism is a camera and an optical character recognition (OCR) application that is able to read a web link 60 provided as text. Another alternate is a short message service (SMS) application, wherein a button in a message is operated to execute the web link 60. Another alternate is an e-mail application, to receive an e-mail including the web link 60 as a uniform resource locator (URL). Even mere manual keypad entry of a URL type web link 60 as text can be used. Accordingly, the electronic device 32 of the signer 30 can be a smart phone, a tablet type computer, a personal computer (PC), etc.

Similarly, the signer 30 only needs applications that are already, usually even inherently, present in their own trusted and familiar electronic device 32. The browser application 44 needs to be present, but it can be any modern browser able to handle hypertext mark-up language version 5 (HTML5). If the browser application 44 handles SMS messages, no other applications are needed. Alternately or additionally, if one or more other applications 46 are present that can read QR (or other scanned) codes, or that can perform OCR on an image, or that can receive e-mails with URLs, these can be used.

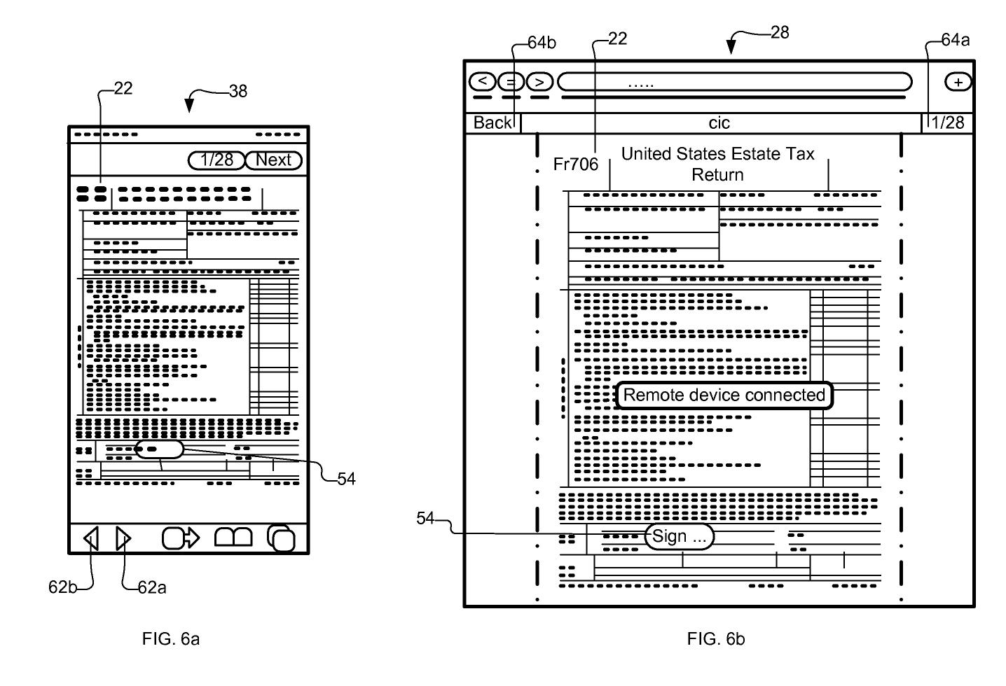

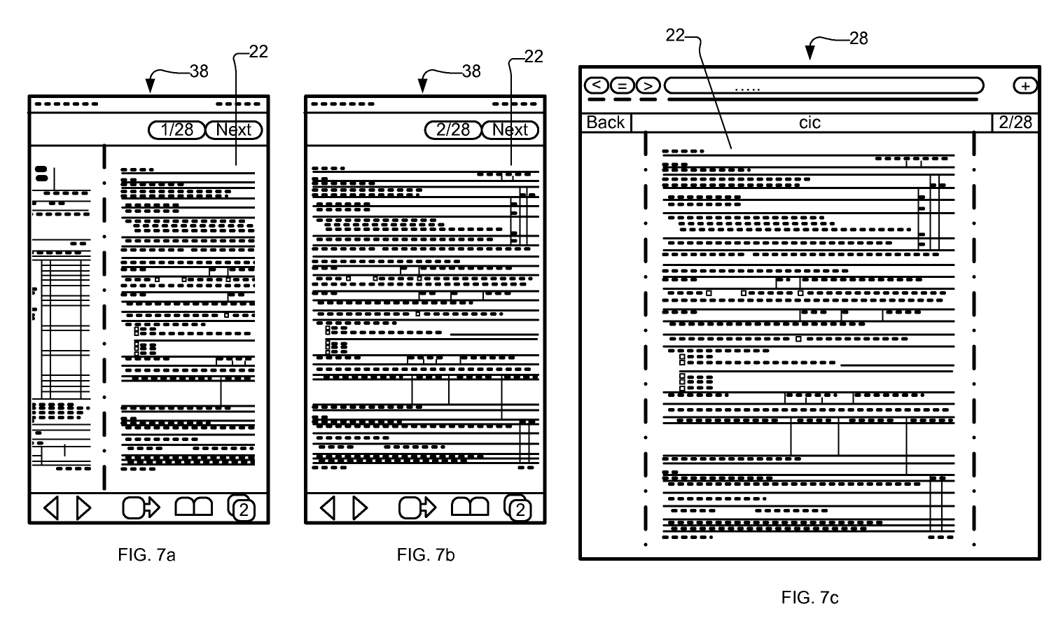

Continuing with the present example, FIGS. 6a-b respectively show what the signer 30 sees on their electronic device 32 and what the agent 26 sees on their terminal 28. They see the same views of the document 22 and if the signer 30 browses to a different location in the document 22 (FIGS. 7a-b) the agent 26 co-browses to the same location in the document 22 (FIG. 7c).

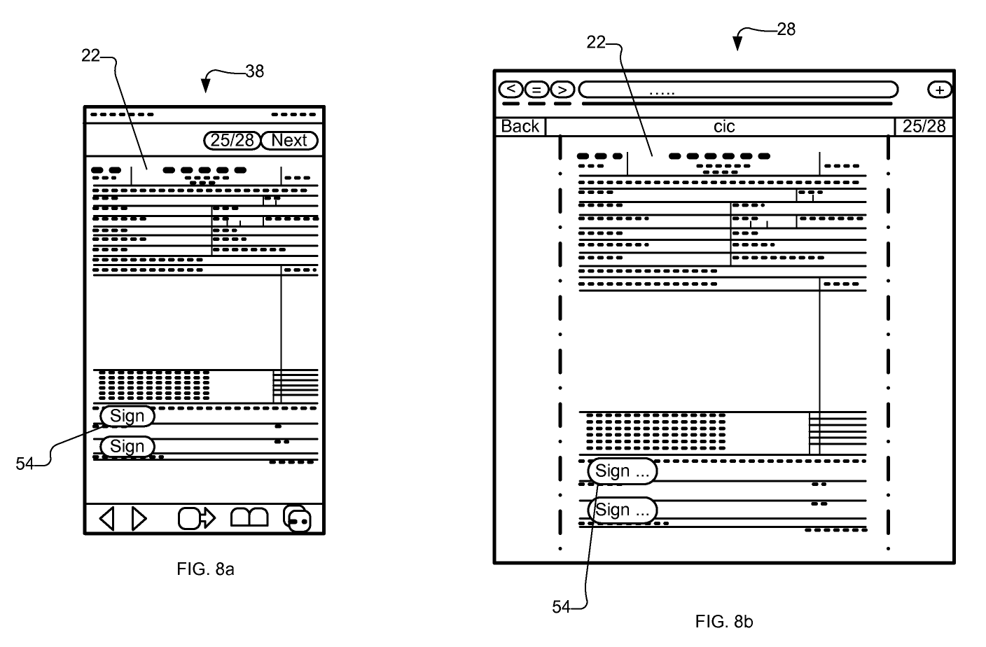

FIG. 6a further shows how the signer 30 has navigation controls 62a-b he can operate to move to a next or previous signature field 54 or attention point 50. And FIG. 6b further shows how the agent 26 similarly has navigation controls 64a-b he can operate to move to a next or previous signature field 54 or attention point 50. The navigation controls 62a-b, 64a-b permit the signer 30 and the agent 26 to browse throughout the document 22, moving forward and backward to important locations as desired. Of course, conventional page controls can also be used to move forward and backward a page at a time, or up and down within a page. If data fields 52 are present, they can be completed or not, as desired. The signer 30 and the agent 26 can handle any questions or comments in real time. Ultimately, the signer 30 and the agent 26 co-browse to the end of the long document 22 (FIGS. 8a-b), and it is time for the signer 30 to formally sign the document 22.

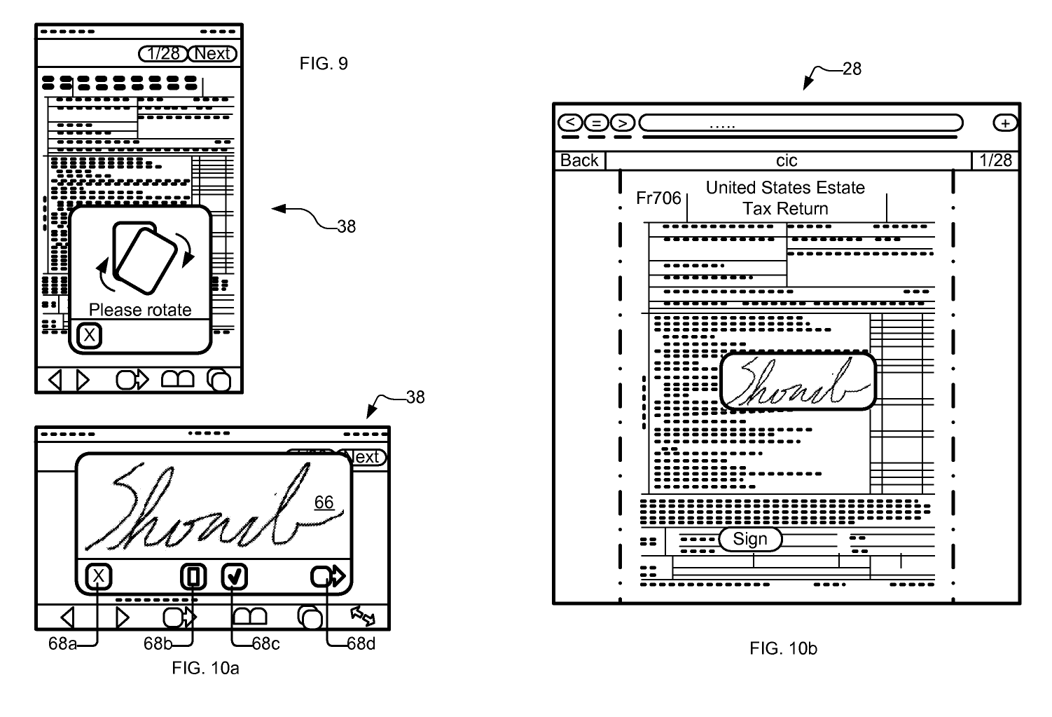

In FIG. 9 the signer 30 has returned to page one of the document 22 and there activated the (first) signature field 54 (the act of activation is straightforward but the manner of activation may vary based on the nature of the electronic device 32, for instance, a screen tap on a signature field 54 can be used if the electronic device has a touch screen). Since the signer 30 here is using an electronic device 32 with a small screen 38, they are instructed to rotate the electronic device 32 from portrait to landscape orientation.

FIGS. 10a-b respectively show what the signer 30 sees on his electronic device 32 and what the agent 26 sees on his terminal 28, as the signer signs the document 22. The signer 30 here has entered his signature in cursive script using the touch screen capability of the screen 38 of this particular electronic device 32.

Continuing with FIG. 10a, the screen 38 shows a written signature box 66 being employed with this embodiment of the signature system 10. This written signature box 66 has a cancel control 68a (“X” button), a start over button 68b (trashcan icon), a text button 68c (pen and paper icon), and an enter button 68d (arrow to right icon).

For the sake of this example, accept that the signer 30 wants to sign with their device now without using its touch screen. The signer 30 navigates to the last signature field 54 (coincidentally on the last page of the document 22), and activates the (last) signature field 54. Since the signer 30 here is using an electronic device 32 that has a touch screen, the written signature box 66 will typically appear by default. Now the signer 30 can operate the text button 68c. If an electronic device 32 did not have a touch screen, the text signature box described below could be the default.

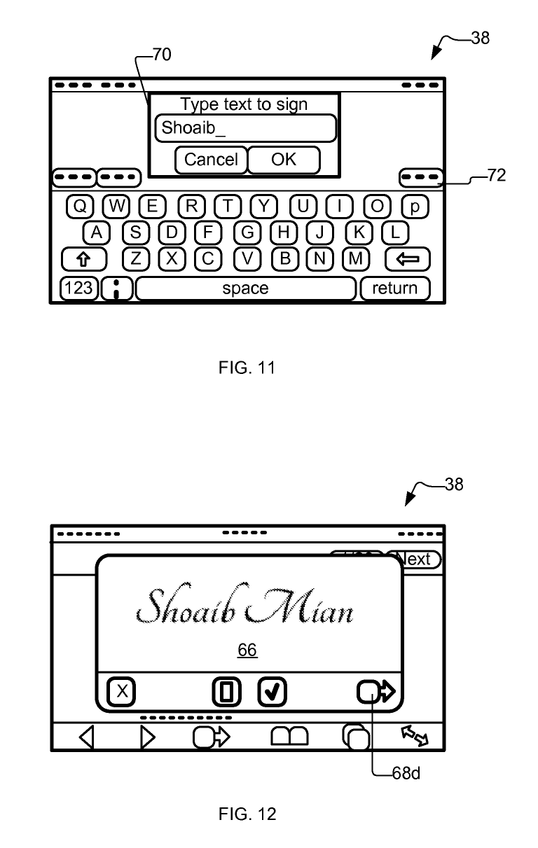

FIG. 11 shows the written signature box 66 replaced by a text signature box 70, into which the signer 30 is entering their signature as text. Once the signer 30 is finished they here operate a done button 72, and FIG. 12 shows how the written signature box 66 now reappears and what will be entered as the signature, once the signer 30 operates the enter button 68d.

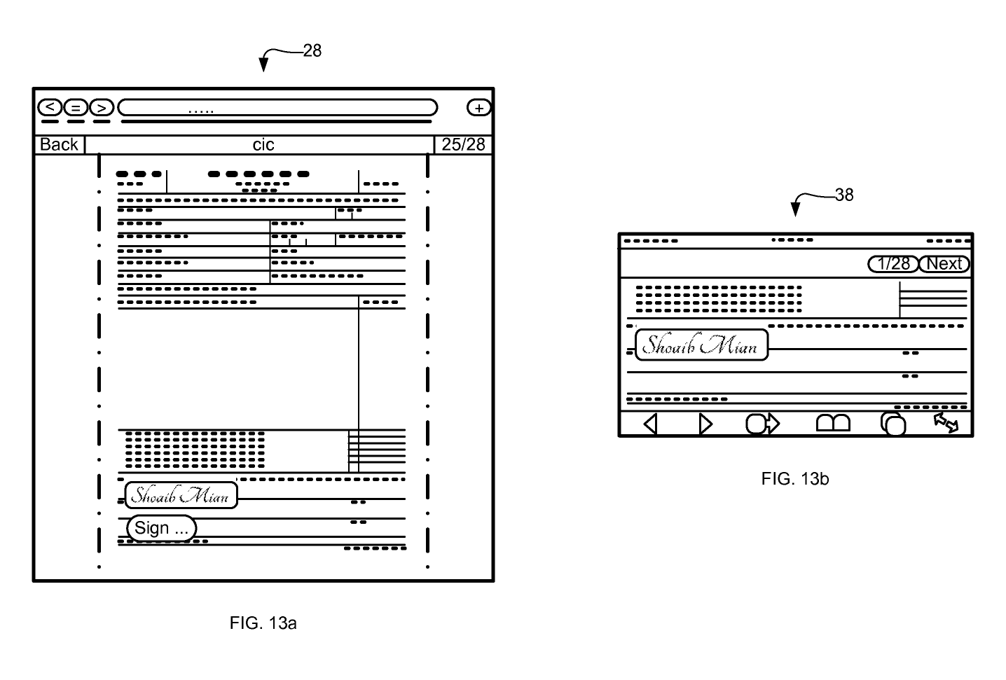

FIGS. 13a-b respectively show what the signer 30 sees on his electronic device 32 and what the agent 26 sees on his terminal 28 after the signer 30 has operated the enter button 68d. At this point the ceremonial act of signing is complete, and copies of the signed document 22 are typically stored on both the agent-side 12 and the signer-side 14, in the server 18, e.g., in the database 24, and in the electronic device 32. Optionally, the agent-side 12 can send a copy of the signed document 22 to the electronic device 32, say, in an e-mail as an attachment. This will facilitate the signor 30 with records keeping.

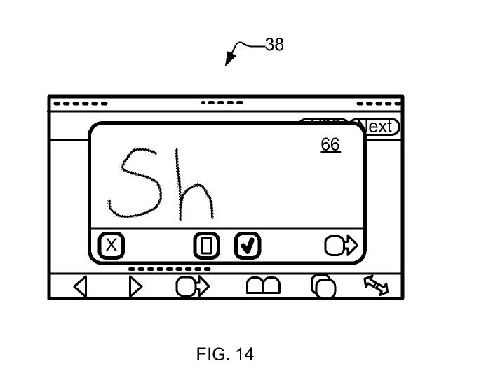

FIG. 14 shows the written signature box 66 again. Here the signer 30 is entering their signature, but it can be seen that the signature may not be aesthetically pleasing. One option to deal with this is to read the signature as entered and to convert it to text, for instance, as the signature appears in FIG. 12. Another option is to smooth the signature as it is entered, for instance, by treating the signature strokes as a series of free form or spline curves and then combining these to reduce the quantity or to otherwise manipulate them to be more visually pleasing.

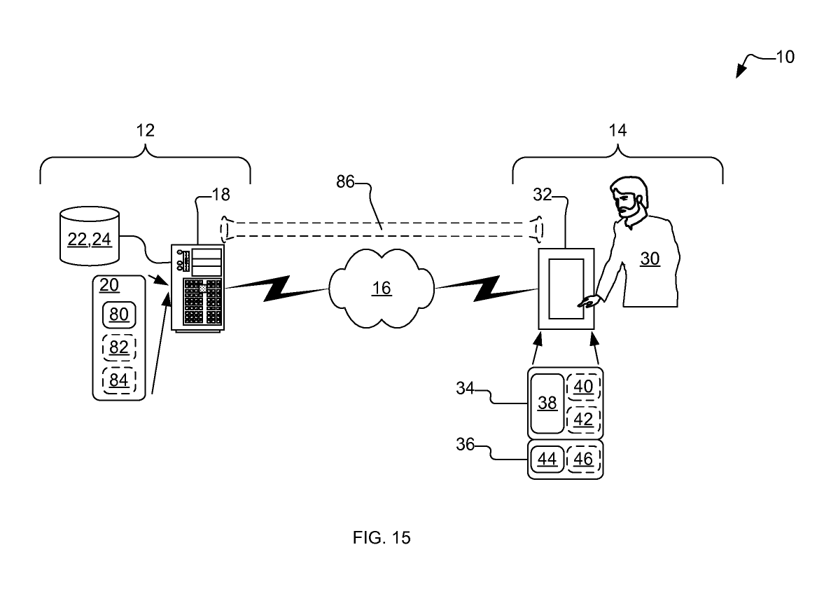

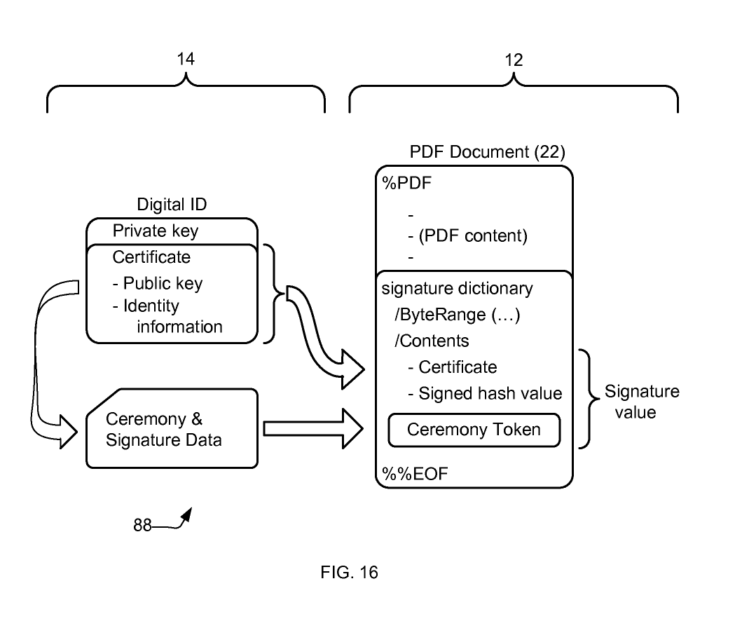

FIG. 15 is a stylized overview of the inventive signature system 10 being employed, in some respects showing more detail than FIG. 1, in some other respects omitting redundant detail, and in some other respects introducing optional features that are now discussed. FIG. 15 shows how the server application 20 running on the server 18 on the agent-side 12 includes a sockets module 80, an optional retry module 82, an optional audit module 84, and how the server application 20 optionally can create a secure channel 86 to the electronic device 32 of the signer 30. Here as well, ghost outline is used to emphasize which elements are optional.

The sockets module 80 employs the WebSockets capability of HTML5 to permit bidirectional communications between the server 18 and the HTML5 (or equivalent) capability of the browser application 44 running in the electronic device 32. The WebSocket specification defines an application programming interface (API) establishing “socket” connections between a browser and a server for full-duplex communications channels over a single transmission control protocol (TCP) socket. Of particular utility here, such a connection is persistent between the client browser and the server and either end can start sending data at any time. In addition, the communications are done over TCP port number 80, which in those environments that block non-standard Internet connections using a firewall. The WebSocket protocol is currently supported in several browsers including, current versions of Google Chrome™, Internet Explorer™, Firefox™, Safari™, and Opera™. Accordingly, embodiments of the sockets module 80 can permit bidirectional control of the signature system 10 from either the agent-side 12 or the signer-side 14.

Unlike prior art approaches, such as long polling where an HTTP connection to a server is kept open and poor connectivity can undermine completing transactions, the WebSocket protocol permits one approach to implementing the retry module 82, and thus helping to ensure that a signature ceremony is completed entirely in one attempt.

The audit module 84 can record details about transactions, consistent with general best practices for important transactions. In addition, the audit module 84 can also record any other details that are present in transactions conducted with the signature system 10. Particularly when working with the WebSockets capability of the sockets module 80, any action or event that happens on the signer-side 14 during a signing process can be recorded and logged into an audit trail that can be stored (e.g., into the ISID, described below). Thus, for instance, raw and final signatures can be recorded, unlike traditional physical documents where only a final signature appears. As another example, physical documents typically provide little if any information about the speed, pressure of finger, etc. of executing a signature, yet these can be an important biometric details when determining the validity of a signature.

Implementations of the WebSocket protocol typically use a new URL “ws:” schema for WebSocket connections. One approach to implement the secure channel 86 between the server 18 and the electronic device 32 is to use a new URL “wss:” schema for secure WebSocket connection in the same way that “https:” is used for secure HTTP connections. Alternately, the secure channel 86 can be implemented in the inventive signature system 10 using other approaches.

Changing tact, it can be seen in FIG. 15 that the optional agent 26 and their terminal 28 have been omitted. This is intentional to emphasize that the inventive signature system 10 can handle simpler signature scenarios without these elements being present at all, or that they may be present in the overall environment in which the signature system 10 is used but not be used unless or until advantageous or necessary. For instance, simpler transactions typically will not require an agent 26 to be present in real time to assist a signer 30.

FIG. 16 is a block diagram showing details of a signature in a document 22, once applied by the signature system 10. Data in the signer-side 14 and the agent-side 12 are shown. In particular, using a certificate (e.g., a public-key infrastructure (PM) certificate, information and events related to the signature ceremony (e.g., signer, time stamp, IP address, page view, mouse positions, etc.), signature data (gravity prompt, biometric data, etc.), user name, user ID, hardware device, browser type and geo-location are digitally signed and encrypted into a security identifier (SID) which the present inventor calls an ISID (based on the inventors' employer's iSign™). And the ISID is made a part of the document 22.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A process (10) for a signer (30) to apply a signature, wherein the signer has a personal electronic device (32) that includes a browser application (44), a screen (38), and an input unit (38, 42), the process comprising:
providing the personal electronic device (32) of the signer (30) with a web link (60) to an electronic document (22) at a remote server (18), wherein said an electronic document (22) includes a signature field (54);
activating said web link (60) on the personal electronic device (32) with the browser application (44) to form a connection between the personal electronic device (32) and said remote server (18) via a communications network (16);
presenting a signor-side image copy of said electronic document (22) with said signature field (54) on the screen (38) of the personal electronic device (32);
accepting the signature of the signer (30) into said signature field (54) from the input unit (38, 42) of the personal electronic device (32); and
communicating said electronic document (22) containing the signature of the signer (30) to said remote server (18).

2. The process of claim 1, wherein said web link (60) includes a code readable by the personal electronic device (32).

3. The process of claim 2, wherein said code includes a uniform resource locator (URL).

4. The process of claim 2, wherein said code includes quick response (QR) code.

5. The process of claim 1, wherein said connection between the personal electronic device (32) and said remote server (18) via said communications network (16) includes a secure channel (86).

6. The process of claim 1, wherein the input unit (38, 42) is a touch screen capability of the screen (38).

7. The process of claim 6, wherein the signature of the signer (30) includes cursive script input into said signature field (54).

8. The process of claim 1, further comprising:
generating a security identifier (SID) (88) in the electronic device (32); and
including said security identifier (SID) (88) in said electronic document (22) communicated to said remote server (18).

9. The process of claim 1, wherein:
an agent-side image copy of said electronic document (22) with said signature field (54) is presented on a terminal (28) of an agent (26) that is remote from the signor (30) on said communications network (16); and
the process further comprising:
co-browsing within said signor-side image copy and as said agent (26) browses within said agent-side image copy, thereby permitting bidirectional control by the signor (30) and said agent (26).

10. A computer program (10), embodied on a non-transitory, tangible computer readable storage medium, for a signer (30) to apply a signature, wherein the signer has a personal electronic device (32) that includes a browser application (44), a screen (38), and an input unit (38, 42), the computer program comprising:
a code segment that provides the personal electronic device (32) of the signer (30) with a web link (60) to an electronic document (22) at a remote server (18), wherein said an electronic document (22) includes a signature field (54);
a code segment that activates said web link (60) on the personal electronic device (32) with the browser application (44) to form a connection between the personal electronic device (32) and said remote server (18) via a communications network (16);
a code segment that presents a signor-side image copy of said electronic document (22) with said signature field (54) on the screen (38) of the personal electronic device (32);
a code segment that accepts the signature of the signer (30) into said signature field (54) from the input unit (38, 42) of the personal electronic device (32); and
a code segment that communicates said electronic document (22) containing the signature of the signer (30) to said remote server (18).

11. The computer program of claim 10, wherein said code segment that activates said web link (60) reads a code.

12. The computer program of claim 11, wherein said code includes a uniform resource locator (URL).

13. The computer program of claim 11, wherein said code includes quick response (QR) code.

14. The computer program of claim 10, wherein said code segment that activates said web link (60) uses a secure channel (86) for said connection between the personal electronic device (32) and said remote server (18).

15. The computer program of claim 10, wherein the input unit (38, 42) is a touch screen capability of the screen (38) and said code segment that accepts the signature of the signer (30) into said signature field (54) accepts cursive script input.

17. The computer program of claim 10, further comprising:
a code segment that generates a security identifier (SID) (88) in the electronic device (32); and
a code segment that includes said security identifier (SID) (88) in said electronic document (22) communicated to said remote server (18).

18. The computer program of claim 10, wherein:
an agent-side image copy of said electronic document (22) with said signature field (54) is presented on a terminal (28) of an agent (26) that is remote from the signor (30) on said communications network (16); and
the computer program further comprising:
a code segment that co-browses within said signor-side image copy and as said agent (26) browses within said agent-side image copy, thereby permitting bidirectional control by the signor (30) and said agent (26).

19. An apparatus (10) for a signer (30) to apply a signature to a signature field (54) of an electronic document (22), the apparatus comprising:
a personal electronic device (32) that includes a browser application (44), a screen (38), and an input unit (38, 42);
logic that activates a web link (60) on said personal electronic device (32) with said browser application (44) to connect said personal electronic device (32) and a remote server (18) via a communications network (16);
logic that presents a signor-side image copy of the electronic document (22) with the signature field (54) on said screen (38) of said personal electronic device (32);
logic that accepts the signature of the signer (30) into the signature field (54) from said input unit (38, 42) of said personal electronic device (32); and
logic that communicates the electronic document (22) containing the signature of the signer (30) to said remote server (18).

20. The apparatus of claim 19, wherein said personal electronic device (32) is a mobile unit that the signer (30) carries on their person.
